(19) United States
(12) Patent Application Publication
(10) Pub. No.: US 2021/0012393 A1
(43) Pub. Date: Jan. 14, 2021

(54) SYSTEMS AND METHODS FOR DYNAMICALLY CALCULATING NET WORTH USING REAL-TIME SENSOR DATA

(71) Applicant: Bank of America Corporation, Charlotte, NC (US)

(72) Inventors: Ryan Davis, Charlotte, NC (US); Albena N. Fairchild, Indian Trail, NC (US); Crystal M. Sundaramoorthy, Charlotte, NC (US)

(21) Appl. No.: 16/505,894

(22) Filed: Jul. 9, 2019

(51) Int. Cl. G06Q 30/02; G01D 21/02

(52) U.S. Cl. CPC G06Q 30/0278; G01D 21/02

(57) ABSTRACT

A method for evaluating an entity's net worth via a plurality of smart sensors is provided. The method may include determining a range of base-line values for each characteristic associated with a plurality of physical assets. Each physical asset may be coupled to one of the smart sensors. The method may include monitoring periodically to determine a measurable characteristic value for each characteristic and comparing each measured characteristic value to a stored range of base-line values for the characteristic. When a change is detected and is outside the range of base-line values, the method may include transmitting the change from to an edge computing device and modifying a stored monetary base value of each physical asset based on the change. The method may further include generating a total net value of the plurality of physical assets by combining the modified monetary base value of each physical asset.

### FIELD OF TECHNOLOGY

Aspects of the disclosure relate to edge computing. Specifically, aspects of the disclosure relate to using edge computing to evaluate an entity's net worth.

### BACKGROUND OF THE DISCLOSURE

Most people and businesses typically desire to be informed of their net worth. An individual's network may comprise the value of his house, car, jewelry, electronics, and the rest of his personal items. A businesses' net worth may comprise the value of its stocks, equipment, inventory, and any other assets that the business has acquired.

However, calculating a net worth of an individual or an entity is difficult, at least because the value of each of the items owned by the individual or entity is in a constant state of fluctuation. This is due at least in part to the dynamic value of precious metals, stock market performances, real estate market trends, time-based depreciation, and even the physical condition surrounding the item that may contribute a loss in the item's value, such as humidity, exposure to water, mechanical functionality and age.

It would be desirable, therefore, to provide systems and methods to track an individual or entity's assets in real-time to enable a value of the assets to be calculated and, continuously, updated based on one or more relevant characteristics that impact the asset's value.

### SUMMARY OF THE DISCLOSURE

Aspects of the disclosure relate to a method for evaluating an entity's net worth. The method may be imparting at least a portion of a value of a plurality of physical assets of the entity. The physical assets may include but are not limited to one or more of a home, car, contents of a safe deposit box, jewelry, gold and crypto-currency.

The method may be implemented by each of a plurality of smart sensors. Each of the plurality of smart sensors may include a sensor, a microprocessor and wireless communication capabilities.

The method may include determining a range of base-line values for each characteristic associated with each of the plurality of physical assets. Each of the plurality of physical assets may be associated with the entity. Each of the plurality of physical assets may be coupled to one of the plurality of smart sensors.

The method may also include monitoring, periodically, to determine a measurable characteristic value for each characteristic. The method may further include comparing each measured characteristic value to a stored range of base-line values for the characteristic for any significant change in the measured characteristic value. The range of base-line values may be a range of values that signify standard behavior, activity, physical makeup and/or functionality of the asset. As long as the value is within the normal range, the monetary value of the asset may not change.

When the change is outside the range of base-line values for the characteristic, the method may further include transmitting the change in the characteristic value from the smart sensor to the edge computing device. The method may further include modifying, via the edge computing device, a stored monetary base value of each physical asset based on the change in the characteristic value of the physical asset.

The method may further include generating a total net value of the plurality of physical assets by combining, via the edge computing device, the modified monetary base value of each physical asset. Following the generating of the total net value, the method may include transmitting the total net value from the edge computing device to a centralized processor.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative architecture in accordance with principles of the invention.

FIG. 2 shows an illustrative diagram in accordance with principles of the invention.

FIG. 3 shows an illustrative flowchart in accordance with principles of the invention.

FIG. 4 shows another illustrative diagram in accordance with principles of the invention.

### DETAILED DESCRIPTION OF THE DISCLOSURE

An edge computing system for evaluating a plurality of physical assets associated with an entity is provided. The evaluating may be for determining the entity's net worth. The entity, in accordance with embodiments of the invention, may include an individual. The entity may include a small company. The entity may include a large corporation. The entity may further include a plurality of companies.

The net worth of an entity may include a total value of the entity's physical assets and financial assets. In some embodiments, the net worth may include only the entity's physical assets. In other embodiments, the net worth may only include the entity's financial assets.

The system may include a plurality of smart sensors. Each smart sensor may include a sensor, a microprocessor and supporting wireless communication. Each smart sensor may be configured to monitor a characteristic of a physical asset. Each smart sensor may be coupled to one of the physical assets. In some embodiments, each smart sensor may be directly coupled to the physical asset. In other embodiments each smart sensor may be coupled to a receptacle of the physical asset. It should be appreciated that some of the plurality of smart sensors may be directly coupled to the physical asset while some of the plurality of smart sensors may be connected to a receptacle of the physical asset.

Each smart sensor may also include a camera. When the smart sensor detects the modification, the smart sensor may be further configured to trigger the camera to capture a picture. The picture may be stored in the smart sensor. The picture may be stored in a database at an edge device. The picture may also be used to value the physical asset. A smart sensor may include a camera, a picture, a fingerprint scanner and/or RFID chips. The sensor may be one of the aforementioned devices. The sensor may be, in some embodiments, one or more of the aforementioned devices.

The plurality of physical assets may include but are not limited to, one or more of a home, car, contents of a safe deposit box, jewelry, gold and crypto-currency. Physical assets may further include commodities such as gold bars. Each of the plurality of physical assets may include one or more characteristics. Each characteristic may include a characteristic value.

For each characteristic within each physical asset, there may be a smart sensor associated with it to detect for any modification(s) of the characteristic. The modification(s) may affect the value of the characteristic. Modifications to the value of the characteristic may either increase or decrease the value of the physical asset.

The smart sensors that may be included within each physical asset may enable detecting and determining a more accurate value of the physical asset because these sensors may enable real-time data relating to each part of the physical asset. Smart sensors may enable real-time conditions of each physical asset.

Each smart sensor may be configured to monitor the characteristic by monitoring periodically a measurable characteristic value associated with the characteristic. The smart sensor may compare the measured characteristic value to a range of base-line values for the characteristic that may be stored in the smart sensor.

The range of base-line values may include a pre-determined threshold amount of change to the physical asset that may not affect the value of the physical asset. The smart sensor may be configured to determine whether the measured characteristic value is within the range of base-line values for the characteristic or whether it is outside the range of base-line values for the characteristic.

The system may also include an edge computing device. Each smart sensor may be in electronic communication with the edge computing device. The edge computing device may include one or more of an entity's mobile device, smartphone, personal computer (“PC”) and edge server. The edge computing device(s) may be in electronic communication with resources that provide real-time market values. The edge computing device(s) may be configured to retrieve the real-time market values to better and more accurately assess each characteristic.

The edge computing device may include a ledger for storing a monetary base value of each physical asset. The ledger may further be for storing, for each smart sensor, the characteristic being monitored by the smart sensor and the measured characteristic value when it is received from the smart sensor. The ledger may also store, for each smart sensor, the physical asset coupled to the smart sensor.

Each physical asset may have one or more characteristics. Each of these characteristics may include a value. The characteristics of a home may include a real-estate value. The characteristics of a home may also include quality of land and a land moisture level. The characteristics of the home may further include a humidity level. The characteristics of the home may also include physical amenities, home improvements and appliance functionality.

Within a home, the system may include a smart sensor to detect the humidity level in the home. There may be another smart sensor for each appliance in the home. There may be an additional smart sensor to keep track of the structure of the home. The system may also be linked to real-time data associated with real-estate values. The system may be configured to update the value of the home based on the value of real-estate in the location of the home.

The characteristics of the car may include a color of the car and the year the car was manufactured. The characteristics of the car may also include the mileage of the car and the mechanical functionality of the car.

In order to determine the value of the entity's car, the car may also include a plurality of smart sensors. There may be a smart sensor connected to each of the car's subsystems.

There may be a smart sensor to monitor the mileage of the car. As the mileage used on the car increases, the value of the car decreases. The camera within the sensor may capture a picture of the mileage displayed on the dashboard. The picture may be stored in the smart sensor. The mileage amount may be extracted from the picture and saved as a numeric value in order to assess the value of the car.

In some embodiments, the system may be configured to have a smart sensor that may link to the car's on-board diagnostics (“OBD”) system to determine the level of functionality of the car. An OBD system is a computer system that may link to the car's computer processor, sensors, and microchips and may be configured to log any problems or issues present in the car. The OBD system may reveal existing flaws that may include problems with the exhaust, transmission, oil tank and other systems. Linking a smart sensor to the car's OBD system may assist in a more accurate calculation of a value of the car.

The characteristics of jewelry may include a weight of the jewelry and a value of the material of the jewelry. Smart sensors linked to jewelry may include a weighted sensor to detect the weight of each article of jewelry. The jewelry may be made up of one or more precious metals. The jewelry may be gold, silver, platinum and/or other forms of metal. The jewelry may be also made out of precious stones. The system may be in connection with a live-feed of the market-value of each metal and/or precious stones and may be able to determine a real-time value of each article of jewelry.

Each smart sensor that monitors a characteristic is configured to periodically monitor for any changes in the measured characteristic value.

When a smart sensor detects a change outside the range of base-line values for the characteristic that may be stored on the smart sensor, the smart sensor may be configured to transmit the change in the characteristic value to the edge computing device. The edge computing device may overwrite the stored measured characteristic value with the change. The edge computing device may further modify the monetary base value of each physical asset based on the change in the measured characteristic value of the physical asset. The edge computing device may combine the modified base value of each physical asset in order to determine a total net value of the plurality of physical assets associated with the entity.

The combining of the values of each physical asset may include summing the values. The combining may also include applying a weighted factor to each of the values, and/or one or more of the values, and sum the weighted values. The weighting factors may be used to normalize the data to a monetary base value.

The edge computing device may further be configured to transmit the total net value to a centralized processor.

When the change is outside the range of base-line values for the characteristic, the edge computing device may be configured to transmit an alert message to the entity. In some embodiments, the message may be transmitted as a text message or email message. In other embodiments, the edge device may transmit an alert message to the entity's mobile device. The alert message may include identified changes(s) of the physical asset.

When the change is outside the normal range, it may indicate deterioration in a system, appliance and/or function of the physical asset. For example, if the smart sensor detects a level of humidity in parts of the home that may be outside the normal range, this may cause significant damage to the home and decrease the value of the home. Furthermore, by sending an alert message to the entity, the entity may be informed in real-time and may be able to repair the glitch prior to real damage being done. When the entity repairs the issue related to the level of humidity, the smart sensor may be configured to detect a modification outside the range of normal modification. The modification may be outside the normal range and may indicate a significant improvement in the system, appliance and/or function of the physical asset that may now increase the value of the physical asset.

In some embodiments, there may be one smart sensor for each physical asset. In other embodiments, there may be a plurality of smart sensors connected to each physical asset. The monetary value may be a summation of values from a number of smart sensors included in the physical asset. The value may also be based on real-time market data that may be received via a live-feed from an edge computing device associated with the system.

In some embodiments, following the transmittal of the total net value of the physical assets to the centralized processor, the centralized processor may be further configured to retrieve a value of the financial assets associated with the entity from a financial platform. The centralized processor may be further configured to combine the value of the financial assets with the total net value of the physical assets to create a total net worth of the entity. The centralized processor may also be configured to trigger, via the financial platform, an increase to a line of credit for the entity based on an entity threshold level of a net worth.

Furthermore, when an entity's net worth is significantly increased, the financial platform may present an offer(s) and/or a service(s) to the entity based on the level of the increase of the entity's net worth. The financial platform may present the data associated with the entity's net worth to a third party i.e.—insurance company, if the entity gives consent.

In some embodiments, the characteristic values that may be determined by each smart sensor, may be stored as sensor data. The sensor data may be transmitted from the sensors and may be fed in real time to a web application. The web application may upload the sensor data and apply one or more pre-stored algorithms to process the data and output a monetary value.

In other embodiments, the sensor data may be processed using known algorithms such as algorithms known to those skilled in the art used for home appraisals, car appraisals, or any other suitable analysis. For example the Kelley Blue Book® Private Party Value is commonly used to calculate a monetary value of a used car. The characteristic values determined by the smart sensors within a car, in accordance with principles of the invention, may be processed using the Kelley Blue Book® to get an accurate monetary value of the car.

The system may be configured to calculate the monetary value of each physical asset based on one or more pre-set algorithms. Each value from each of the physical assets may contribute to the monetary value of the physical asset. Depreciation of each physical asset may be taken into account in determining the monetary value of the physical asset. The pre-set algorithms may include determining the retail value of each physical asset and deducting a monetary amount of money based on the modifications to the characteristics. The retail value may be based on a purchase price of the physical asset in one or more online stores.

When determining a monetary value of the entity's home, the system, in some embodiments, may use an algorithm used in residential appraisals. The Uniform Residential Appraisal Report (“URAR”) is a common form used in real estate appraisal. The URAR covers a lot of factors of the property. The URAR includes a general description of the design of the property. The URAR also includes neighborhood characteristics. The URAR includes details of the foundation of the property. The URAR includes an exterior description and an interior description of the property i.e.—foundation walls, roof surface, gutters, floors walls and bath floor. The URAR may further include a comparison of the property's characteristics to various other homes that may be similar to the property.

In accordance with principles of the invention, the smart sensors may be connected to various portions of the external part of the home and the internal part of the home to get an accurate value of each characteristic for each part of the home. The data generated by the smart sensors may be fed into a URAR application to calculate the monetary value of the home.

When a home undergoes renovations and/or an upgrade to a part of the home, the smart sensors may be configured to detect these renovations/upgrades and update the characteristic values associated with them. These improvements may increase the net value of the physical asset significantly.

In some embodiments, the plurality of smart sensors may be configured to operate as a network of smart sensors. Such smart sensors may be co-located on or near an entity's physical assets. Each smart sensor within each physical asset may be in electronic communication with one another. Furthermore, each smart sensor(s) connected to each physical asset may be in electronic communication with the plurality of smart sensors from each of the other plurality of physical assets.

Each smart sensor may be configured to perform as a personal asset pattern detector. The smart sensors may use artificial intelligence (“AI”) for detecting the patterns. For example, if the characteristic value in more than one of the sensors of a physical asset decrease, and the characteristic value in more than one sensor from a second and or more physical assets decrease, the network of smart sensors may determine a pattern associated with the entity of the physical assets that may allude to a decrease and/or increase in the financial status of the entity. The pattern may be developed over a threshold of time. The threshold of time may be in certain circumstances, a couple of days. The threshold of time in other embodiments, may be a month or more than a month.

In another embodiment, an edge computing system for evaluating a plurality of physical assets associated with an entity to determine the entity's net worth is provided. The system may include one or more smart sensors. Each smart sensor may be coupled to one of the plurality of physical assets. Each smart sensor may include a sensor, a microprocessor and supporting wireless communication. Each smart sensor may be configured to monitor a characteristic of a physical asset coupled to the smart sensor.

For each smart sensor, the monitoring the characteristic may include monitoring periodically a measurable characteristic value associated with the characteristic and periodically sending the measured characteristic value to an edge computing device. The edge computing device may include a ledger. The ledger may be for storing a monetary base value of each physical asset. The ledger may also be for storing, for each smart sensor, the characteristic being monitored by the smart sensor and a range of base-line values for the characteristic. The ledger may also store, for each smart sensor, the measured characteristic value each time it is received from the smart sensor and the physical asset coupled to the smart sensor.

When the edge computing device receives the measured characteristic value from the smart sensor, the edge computing device may be configured to overwrite the stored measured characteristic value with the received measured characteristic value. The edge computing device may further compare the stored measured characteristic value to the range of base-line values for the characteristic. When a change in the measured characteristic value is outside the range of base-line values for the characteristic, the edge computing device may further be configured to modify the base value of each physical asset based on the change in the characteristic value of the physical asset.

The edge computing device may further combine the modified base value of each physical asset to determine a total net value of the plurality of physical assets associated with the entity. The edge device may further be configured to transmit the total net value to a centralized processor.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is understood that other embodiments may be utilized, and that structural, functional, and procedural modifications may be made without departing from the scope and spirit of the present disclosure.

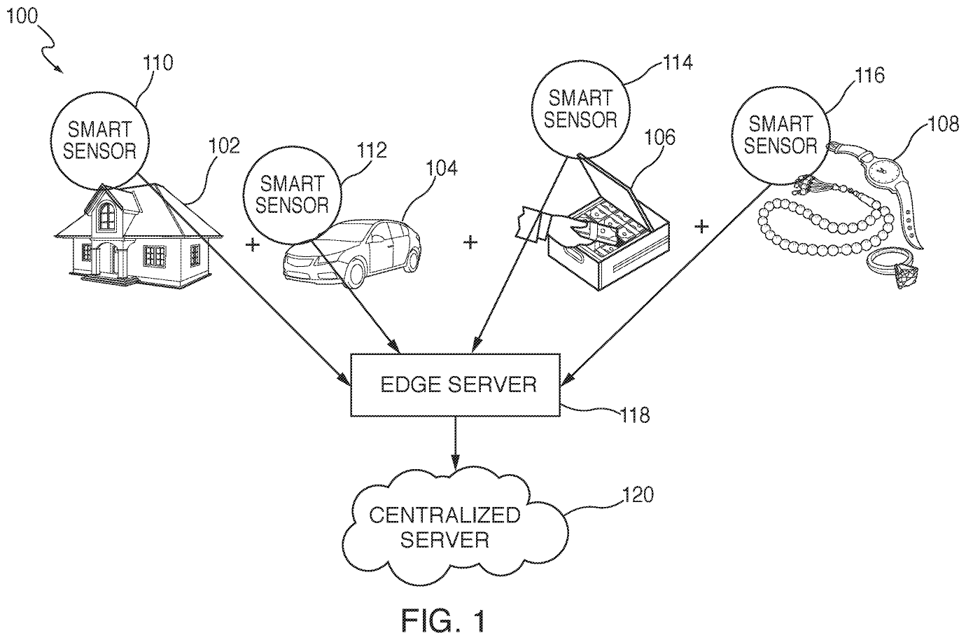

FIG. 1 shows an illustrative architecture of an edge computing system 100. The edge computing system 100 may include smart sensors coupled to a plurality of physical assets. Physical assets 102, 104, 106 and 108 may belong to one entity. The physical assets are not limited to physical assets 102-108. The physical assets may further include but are not limited to real-estate property(s), personal effects including expensive electronic devices and commodities i.e.—gold bars.

Smart sensor 110 may be connected to the entity's home 102. Smart sensor 112 may be connected to the entity's car 104. Smart sensor 114 may be connected to the entity's safe deposit box 106. Smart sensor 116 may be connected to the entity's jewelry 108.

Each of physical assets 102-108 may be connected to more than one smart sensor. Smart sensors 110, 112, 114 and 116 may each represent a plurality of smart sensors. Smart sensor 110, 112, 114 and 116, in some embodiments, may be a single smart sensor.

Physical assets 102-108 and smart sensor 110-116 may be at the front-end of the edge computing system 100.

The home 102 may be connected to many smart sensors. There may be a smart sensor on each exterior portion of the home i.e.—roof, foundation and landscape. There may be a smart sensor on each portion of the interior of the home i.e.—pipes and floors. There may further be a smart sensor on each major appliance in the home. The smart sensors may be communicating electronically.

The car 104 may have numerous smart sensors connected to it. There may be a smart sensor on each major mechanical portion of the car, i.e.—transmission, exhaust etc. There may be a smart sensor connected to the computer processor of the car.

The safe deposit box 106 may be connected to smart sensor 114. The smart sensor may be connected to the box. There may be a plurality of smart sensors connected to each item within the safe deposit box 106.

Jewelry 108 may include a number of articles of jewelry. The jewelry may all be stored together within the entity's possession. There may be a smart sensor connected to each article of jewelry. Each article of jewelry may have different characteristics. Each article of jewelry may also have a different value.

Smart sensors 110-116 may be configured to calculate the monetary value of each of physical assets 102-108. The monetary value may be in real-time. The calculated values may be transmitted to the edge server 118. Edge server 118 may be at the near-end of the edge computing system 100 and may be in close proximity to the front-end of the system. The values of each of the physical assets may change and may be updated periodically to the edge server 118.

Edge server 118 may combine the values of each of the physical assets to determine a total net worth of the plurality of physical assets associated with the entity. The total net worth of the physical assets may be transmitted to the centralized server 120. The centralized server 120 may be at the far-end of the edge computing system 100. The centralized server may be a cloud, the internet, and/or a number of servers at different locations. The centralized server may be in communication with a financial platform and may further determine the total net worth of the entity based on the worth of the physical assets and further based on the net worth of the entity's financial assets.

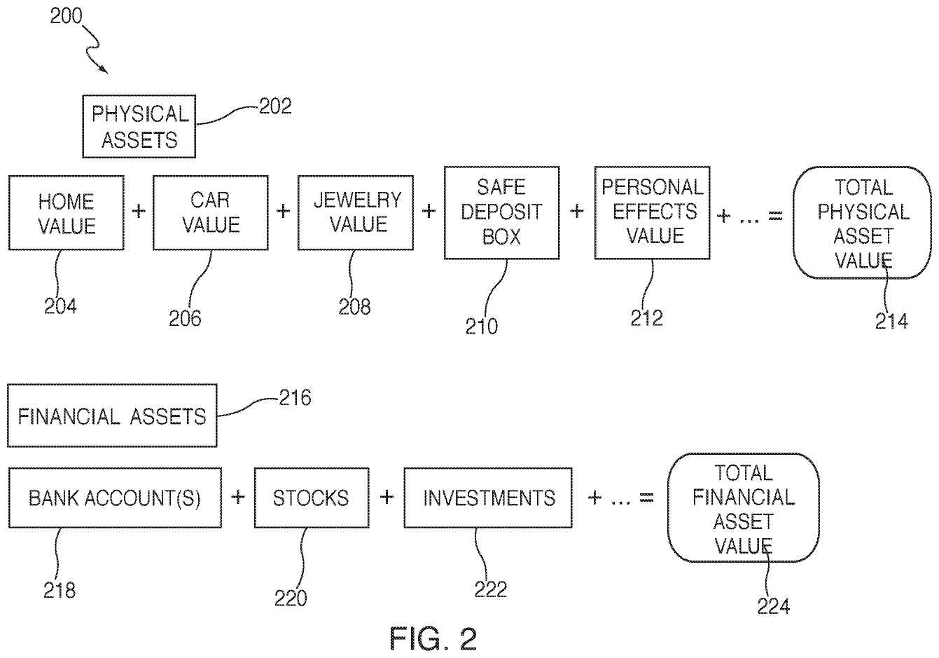

FIG. 2 shows an illustrative exemplary diagram 200 of an entity's physical and financial assets. The assets may not be limited to the physical assets and financial assets displayed in FIG. 2.

The total physical asset value of an entity may be a combination of values. The total physical asset value may include, but is not limited to, the value of the entity's home 204, the value of the entity's car 206, the value of the entity's jewelry 208, the value of the contents of a safe deposit box 210 and the value of the entity's personal effects 212.

The total financial asset value of the entity may be a combination of values. The total financial asset value may include, but is not limited to, the monetary value of the entity's one or more bank accounts 218, one or more stocks owned by the entity 220 and investments of the entity 222.

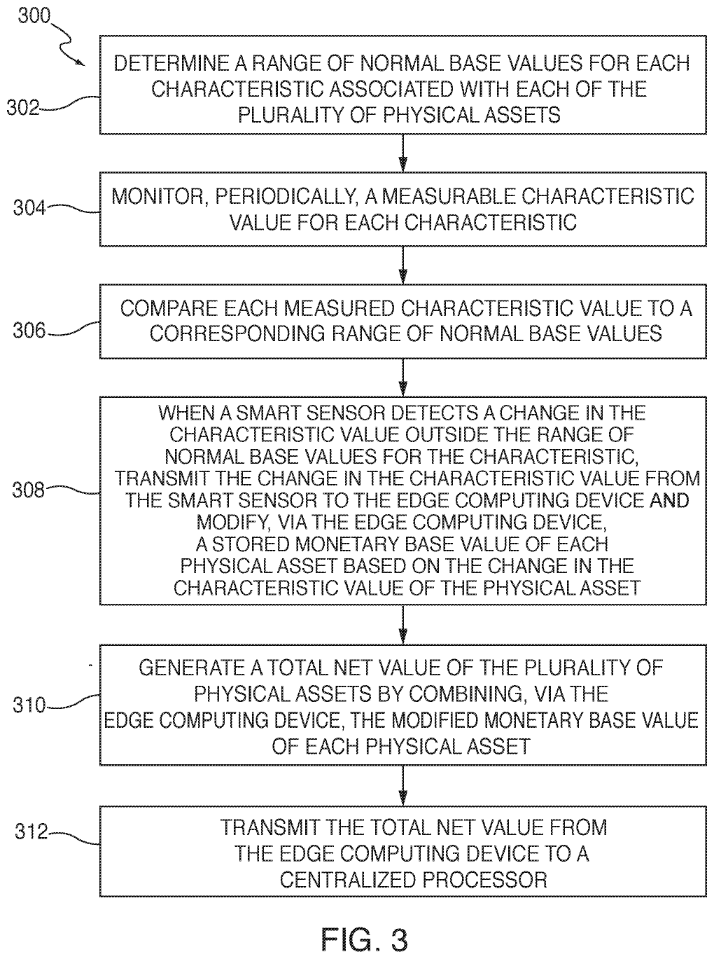

FIG. 3 shows an illustrative flowchart of an edge computing system 300 for determining an entity's net worth. The system may be acting on a plurality of physical assets of an entity. The plurality of physical assets may each be connected to a smart sensor.

At step 302, the system may be configured to determine a range of base-line values for each characteristic that may be associated with each of the plurality of physical assets.

At step 304, the smart sensors may be configured to monitor, periodically, a measurable characteristic value for each characteristic.

At step 306 the system may be configured to compare each measured characteristic value to the corresponding range of base-line values.

At step 308, when a smart sensor detects that a change in the characteristic value is outside the range of the base-line value for the characteristic, the smart sensor may transmit the change in the characteristic value to the edge computing device. The edge computing device may be configured to modify a stored monetary base value of each physical asset based on the change in the characteristic value of the physical asset.

At step 310, the edge computing device may be further configured to generate a total net value of the plurality of physical assets. The generating may include combining the modified monetary base value of each physical asset and calculate a sum of the combined values.

At step 312, the edge computing device may be configured to transmit the total net value to a centralized processor. The centralized processor may be associated with a financial platform.

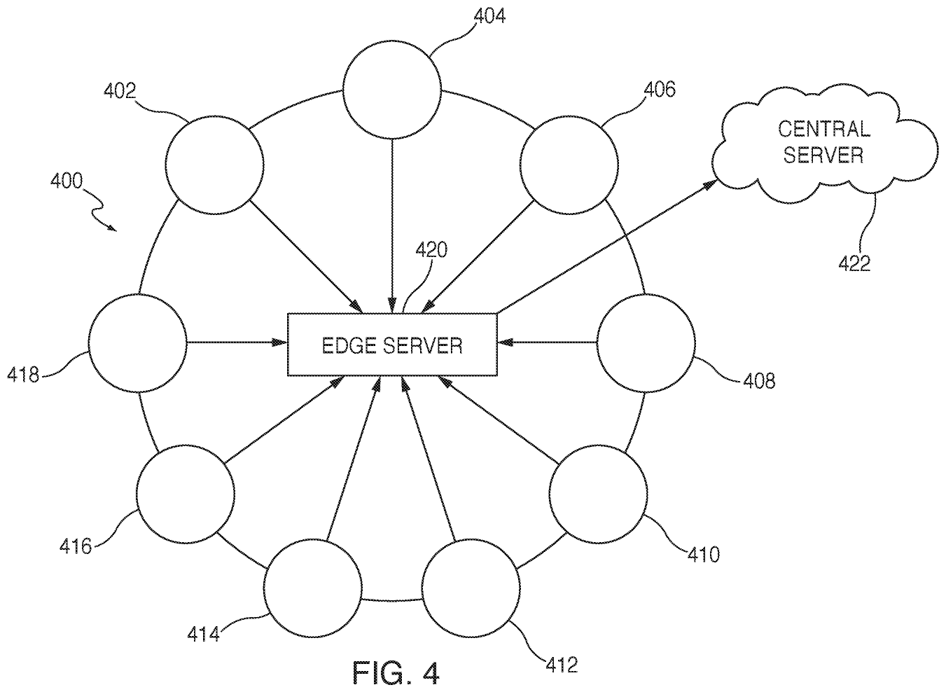

FIG. 4 shows an illustrative diagram of a network of smart sensors 400 in accordance with principles of the invention. Smart sensors 402-418 may be linked to one or more physical assets associated with an entity. The smart sensors may perform as a network and may be in electronic communication with each other. Each smart sensor 402, 404, 406, 408, 410, 412, 414, 416 and 418 may be configured to monitor and detect for any modifications to its linked physical asset. The sensors may generate modification data and may share the data with the network of smart sensors. The smart sensors may use artificial intelligence (“AI”) for detecting asset patterns. The network of smart sensors may determine a pattern associated with the entity of the physical assets that may allude to a decrease and/or increase in the financial status of the entity.

The smart sensors 402-418 may be configured to transmit the generated data and the detected patterns to a near-end edge server 420. The edge server 420 may further process the data and transmit the data to a far-end central server 422. Central server 422 may use the data in evaluating the entity's financial status within a financial platform.

Thus, methods and apparatus for evaluating an entity's net worth are provided. Persons skilled in the art will appreciate that the present invention can be practiced by other than the described embodiments, which are presented for purposes of illustration rather than of limitation, and that the present invention is limited only by the claims that follow.

What is claimed is:

1. An edge computing system for evaluating a plurality of physical assets associated with an entity to determine the entity's net worth, the system comprising:
one or more smart sensors coupled to each of the plurality of physical assets, each smart sensor comprising a sensor, a microprocessor and supporting wireless communication, each smart sensor configured to monitor a characteristic of a physical asset coupled to the smart sensor, the smart sensor monitoring the characteristic by monitoring periodically to determine a measurable characteristic value associated with the characteristic and comparing it to a range of base-line values for the characteristic stored in the smart sensor;
the edge computing device including a ledger for storing a monetary base value of each physical asset and, for each smart sensor:
the characteristic being monitored by the smart sensor;
the measured characteristic value; and
the physical asset coupled to the smart sensor; and
wherein, when a smart sensor detects a change in a characteristic value being monitored, the change being outside the range of the base-line value for the characteristic, the smart sensor is configured to transmit the change in the characteristic value to the edge computing device and the edge computing device is further configured to:
modify the monetary base value of each physical asset based on the change in the characteristic value of the physical asset;
combine the modified base value of each physical asset to determine a total net value of the plurality of physical assets associated with the entity; and
transmit the total net value to a centralized processor.

2. The system of claim 1 wherein the plurality of physical assets comprise one or more of a home, car, contents of a security deposit box, jewelry, commodity and crypto-currency.

3. The system of claim 2 wherein the characteristics of the home comprise quality of land, a land moisture level, a humidity level, appliance functionality, real-estate value, physical amenities and home improvements.

4. The system of claim 2 wherein the characteristics of the car comprise a color, mileage, year and mechanical functionality.

5. The system of claim 2 wherein the characteristics of the jewelry comprise a weight of the asset and a value of gold.

6. The system of claim 1 wherein each smart sensor is physically coupled to the physical asset.

7. The system of claim 1 wherein each smart sensor is coupled to a receptacle of the physical asset.

8. The system of claim 1 where the plurality of smart sensors are a network of smart sensors in electronic communication with one another and configured to generate artificial intelligence data.

9. The system of claim 1 wherein the edge computing device comprises one or more of an entity's mobile device, personal computer and edge server.

10. The system of claim 1 wherein when the change in the measured characteristic value for each characteristic of a physical asset is within the range of the base-line value, the monetary base value of the physical asset is constant.

11. The system of claim 10 wherein, when the change in the measured characteristic value is outside the range of the base-line value, the system is further configured to transmit an alert message to the edge computing device, the alert message including the change.

12. The system of claim 1 wherein following the transmittal of the total net value of the physical assets to the centralized processor, the centralized processor is further configured to:
retrieve a value of financial assets associated with the entity from a financial platform;
combine the value of the financial assets with the total net value of the physical assets to create a total net worth of the entity; and
increase a line of credit for the entity based on a threshold level of a net worth.

13. A method for evaluating an entity's net worth, the method imparting at least a portion of a value of a plurality of physical assets of the entity, the method implemented by each of a plurality of smart sensors, each of the plurality of smart sensors comprising a sensor, microprocessor and supporting wireless communication, each of the plurality of smart sensors in electronic communication with an edge computing device, the method comprising:
determining a range of base-line values for each characteristic associated with each of the plurality of physical assets, each of the plurality of physical assets being associated with the entity, each of the plurality of physical assets coupled to one of the plurality of smart sensors;
monitoring, periodically, a measurable characteristic value for each characteristic;
comparing each measured characteristic value to a corresponding range of base-line values;
wherein, when a smart sensor detects a change in the characteristic value being monitored, the change being outside the range of base-line values for the characteristic, the method further comprises:
transmitting the change in the characteristic value from the smart sensor to the edge computing device;
modifying, via the edge computing device, a stored monetary base value of each physical asset based on the change in the characteristic value of the physical asset;
generating a total net value of the plurality of physical assets by combining, via the edge computing device, the modified monetary base value of each physical asset; and
transmitting the total net value from the edge computing device to a centralized processor.

14. The method of claim 13 wherein the plurality of physical assets comprise one or more of a home, car, contents of a security deposit box, jewelry, gold and crypto-currency.

15. The method of claim 13 wherein the generating the total net value, via the edge computing device further comprises receiving a live-feed from third party resources and further generating the total net value based on the live-feed, the live-feed comprising real-time data associated with current stock market prices and real-estate value.

16. An edge computing system for evaluating a plurality of physical assets associated with an entity to determine the entity's net worth, the system comprising:
one or more smart sensors coupled to each of the plurality of physical assets, each smart sensor comprising a sensor, a microprocessor and supporting wireless communication, each smart sensor configured to monitor a characteristic of a physical asset coupled to the smart sensor, the smart sensor monitoring the characteristic by monitoring periodically a measurable characteristic value associated with the characteristic and periodically sending the measured characteristic value to an edge computing device;
the edge computing device including a ledger for storing a monetary base value of each physical asset and, for each smart sensor:
the characteristic being monitored by the smart sensor;
a range of base-line values for the characteristic;
the measured characteristic value; and
the physical asset coupled to the smart sensor; and
wherein, the edge computing device received the measured characteristic value from the smart sensor, the edge computing device is configured to:
overwrite the stored measured characteristic value with the received measured characteristic value;
compare the stored measured characteristic value to the range of base values for the characteristic and when a change in the measured characteristic value is outside the range of base values for the characteristic, the edge computing device is further configured to:
modify the base value of each physical asset based on the change in the characteristic value of the physical asset;
combine the modified base value of each physical asset to determine a total net value of the plurality of physical assets associated with the entity; and
transmit the total net value to a centralized processor.

17. The system of claim 16 wherein the plurality of physical assets comprise one or more of a home, car, contents of a security deposit box, jewelry, gold and crypto-currency.

18. The system of claim 16 wherein each smart sensor is physical coupled to the physical asset.

19. The system of claim 16 wherein each smart sensor is coupled to a receptacle of the physical asset.

20. The system of claim 16 wherein the smart sensor further comprises a camera and when the smart sensor detects the change, the smart sensor is further configured to trigger the camera to capture a picture.
